(19) United States
(12) Patent Application Publication
(10) Pub. No.: US 2004/0264853 A1
(43) Pub. Date: Dec. 30, 2004

(54) Light probe for ultraviolet light activated gene transduction

(76) Inventors: Edward M. Schwarz, Rochester, NY (US); Paul T. Rubery, Honeoye Falls, NY (US); Thomas H. Foster, Rochester, NY (US); Michael D. Maloney, Pittsford, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/769,392

(22) Filed: Jan. 30, 2004

Related U.S. Application Data
(60) Provisional application No. 60/444,493, filed on Jan. 31, 2003.

(51) Int. Cl. G02B 6/26

(52) U.S. Cl. 385/31

(57) ABSTRACT

In accordance with the present invention, a light probe is provided for treating a patient through the use of ultraviolet light activated gene therapy. Embodiments of the present invention include a light probe structure for the utilization of light activated gene therapy to repair and/or rebuild damaged cartilage or a component of a functional spinal unit (FSU) by introducing a desired gene into a patient's tissue.

### REFERENCE TO RELATED APPLICATION

This application claims priority under 35 U.S.C. §119(e) to U.S. Provisional Application 60/444,493, filed on Jan. 31, 2003, the disclosure of which is hereby incorporated by reference.

### GOVERNMENT INTEREST

This invention was made with Government support under NIH Contract #AR45972, an RO1 grant awarded by NIAMS. The Government has certain rights in the invention.

### BACKGROUND OF THE INVENTION

1. Field of the Invention

The invention relates generally to the field of gene therapy. According to the present invention, devices are provided for the combined use of light activated gene transduction (LAGT) employing ultraviolet light and recombinant adeno-associated virus (r-AAV) for the purpose of introducing a desired gene into a patient's tissue.

2. Description of the Related Art

Somatic cell gene therapy is a form of treatment in which the genetic material of a target cell is altered through the administration of nucleic acid, typically in the form of DNA. In pursuit of effective in vivo administration routes, scientists have harnessed the otherwise potentially deleterious ability of viruses to invade a target cell and “reprogram” the cell through the insertion of viral DNA. By encapsulating desirable genetic material in a viral particle, or “vector,” minus some of the viral DNA, the effective and targeted delivery of genetic material in vivo is possible. As applied to specific treatments, gene therapy offers the ability to adjust the expression of desirable molecules, including both intracellular and extracellular proteins, to bring about a desired biological result.

In particular, the desirable qualities of adeno-associated viruses (AAV) have led to further study of potential gene therapy uses. As a vehicle for gene therapy recombinant forms of AAV, or r-AAV, offer many advantages including the vector's ability to infect non-dividing cells (e.g., chondrocytes, cells within cartilage), the sustained target gene expression, the low immune response to the vector, and the ability to transduce a large variety of tissues. The AAV contains a single strand DNA (ssDNA) genome. Under normal conditions AAV is present in humans in a replication incompetent form, due to the fact the AAV alone does not encode the enzyme required for replication of the second DNA strand. Successful r-AAV transduction often requires the presence of a co-infection with an adenovirus or the exposure of the host cell to DNA damaging agents, such as γ-irradiation. The introduction of either the co-infection or the DNA damaging agents dramatically induces the rate limiting step of second strand synthesis, i.e. the second strand of DNA which is synthesized based on the vector inserted first strand. However, making use of these DNA damaging agents is impractical because the administration of an adenovirus co-infection to a patient is not practical or desirable and the site specific and safety issues involved with using γ-irradiation are undesirable as well.

In the past, attempts have been made to induce r-AAV transduction in vitro using UV radiation having a wavelength of 254 nm. Unfortunately, no effective therapeutic method or apparatus was developed based on these experiments due to the long exposure times involved with using 254 nm UV radiation, the difficulties of delivering 254 nm UV radiation to a surgical target site, and the inability to position the 254 nm UV light source so as to allow effective penetration of a target cell.

### SUMMARY OF THE INVENTION

Preferred embodiments of the present invention provide a structure useful in treating a patient using light activated gene therapy.

In accordance with an embodiment of the present invention, an ultraviolet light probe for activating transduction of a UV activated viral vector in target cells is provided. The light probe includes an elongated exterior housing having a distal end and a proximal end. In addition, a light guide, which is partially surrounded by the probe exterior housing, extends toward the distal end. An optical connector is joined with the light guide to channel ultraviolet light into the light guide when connected to a light source. A light guide terminator is located at the distal end of the exterior housing. The light guide terminator is configured to output ultraviolet light from the light guide. The light guide terminator can comprise a tip lens, but need not.

In accordance with another embodiment of the present invention, a method of activating a viral vector in a patient is provided. The end of a light transmitting tool is inserted into a patient so as to direct light towards the viral vector in the patient. Ultraviolet light having a wavelength of from about 280 to about 400 nm ultraviolet light is then transmitted through the core of the light transmitting tool to the end of the tool. The ultraviolet light is then outputted to the viral vector in the patient in order to activate the viral vector.

In accordance with yet another embodiment of the present invention, a method of reusing a light probe body portion of a light probe configured to output 255 to 400 nm ultraviolet light to activate a viral vector in a patient is provided. A first light probe tip is removed from the light probe body. A second light probe tip is then attached to the body.

In accordance with yet another embodiment of the present invention, a detachable tip of an ultraviolet light probe is provided for activating a viral vector in a patient. The detachable tip includes an optical connector at a proximal end of the tip and an optical output at the distal end of the tip. The optical output is configured to output ultraviolet light having a wavelength from about 280 nm to about 400 nm in order to activate a viral vector in the patient. A fiber optic core extends between the optical connector and the optical output.

A feature of certain preferred embodiments of this invention is the provision of a light probe which, when used in conjunction with a light activated gene therapy system, allows the avoidance of the problems involved with using UV and γ-irradiation through the use of locally administered, long wavelength UV (i.e., greater than or equal to 255 nm) radiation in order to induce the target cell to more effectively stimulate the transduction of a UV activated viral vector, such as recombinant adeno-associated virus (r-AAV).

Another feature of certain preferred embodiments of the present invention, is the provision of a light probe advantageously configured to access a target site, such as a patients' spine or joint, and treat this target site by locally administering ultraviolet light to cells at the target site which are infected with a UV activated viral vector, such as r-AAV, containing a desired gene.

### BRIEF DESCRIPTION OF THE DRAWINGS

FIG. 1 is a flowchart of a method of treating target cells in a patient's tissue by activating the transduction of a UV light activated viral vector using a light probe, in accordance with an embodiment of the present invention.

FIG. 2A is a side view schematic of a component of a long wavelength UV radiation system, including a light source and user interface.

FIGS. 2B is a schematic of another component of the long wavelength UV radiation system, including a light probe, which in conjunction with the light source and user interface shown in FIG. 2A, forms the in vivo long wavelength UV radiation system, in accordance with another embodiment of the present invention.

FIG. 2C is perspective schematic of an external light probe which, in conjunction with the component having the light source and user interface shown in FIG. 2A, forms the ex vivo long wavelength UV radiation system configured for external applications, in accordance with an alternate embodiment of the present invention.

FIG. 2D is a alternate arrangement of the light probe shown in FIG. 2A, the light probe having an angled tip.

FIG. 3 is a schematic of an injecting device for introducing a UV activated vector into a patient's tissue, in conjunction with the long wavelength UV radiation system, shown in FIGS. 2A and 2B.

FIG. 4 is a method of treating a patient's cartilage using a UV activated viral vector and a long wavelength UV radiation system, in accordance with yet another embodiment of the present invention.

FIG. 5A-5D are perspective schematics of implants for use in conjunction with the long wavelength UV radiation systems and method provided herein, in accordance with another embodiment of the present invention.

FIG. 5E is a cross-section schematic of the expanded implant of FIG. 6D, the expanded implant shown located between two vertebra.

FIG. 6 is a flowchart of a method of treating a patient's tissue using a UV light activated viral vector and a solid platform.

FIG. 7 is a graph of the results of the procedure described in Example 1, the multiplicity of infection being 10.

FIG. 8 is a graph of the results of the procedure described in Example 1, the multiplicity of infection being 100.

FIG. 9 is a graph of the results of the procedure described in Example 1, the multiplicity of infection being 1000.

### DETAILED DESCRIPTION OF THE PREFERRED EMBODIMENT

The subject matter of this application is related to that of U.S. application Ser. No. 10/357,273, filed Jan. 31, 2003, and U.S. application Ser. No. 10/357,271, filed Jan. 31, 2003, published as US 2003-0236394. The complete disclosures of these related applications are incorporated by this reference thereto.

The term “AAV” refers to adeno-associated virus, while “r-AAV” refers to recombinant adeno-associated virus. Preferably, r-AAV includes only the desired gene to be introduced into the patient's tissue and the flanking AAV inverted terminal repeats (ITRs) that serve as the packaging signals.

“Ultraviolet radiation” and “ultraviolet light,” also known gas “UV”, refer to the portions of the electromagnetic spectrum which have wavelengths shorter than visible light. The range of wavelengths considered to be ultraviolet radiation, from about 4 nanometers to about 400 nanometers, is further subdivided into three subgroups, UVA, UVB, and UVC. “UVA” is the portion of ultraviolet radiation which includes wavelengths from 320 nm up to and including 400 nm. “UVB” is the portion of ultraviolet radiation which includes wavelengths from 280 nm up to and including 320 nm. “UVC” is the portion of ultraviolet radiation having a wavelength less than 280 nm.

The term “long wavelength UV” refers to ultraviolet radiation or light having a wavelength equal to or greater than 255 nm, but not more than 400 nm.

A “viral vector” refers to a virus, or recombinant thereof, capable of encapsulating desirable genetic material and transferring and integrating the desirable genetic material into a target cell, thus enabling the effective and targeted delivery of genetic material both ex vivo and in vivo. A “UV activated viral vector” or “UV light activated viral vector” is any virus, or recombinant thereof, whose replication is regulated by ultraviolet light. Recombinant adeno-associated virus (r-AAV) is included in the group of viruses labeled UV activated viral vectors. A “solid platform” is any structure designed to be inserted into the body for the purpose of aiding the treatment of the target site proximate to where the solid platform is inserted.

The term “LAGT” refers to light activated gene transduction, while “LAGT probe” or “light probe” or “long UV wavelength light probe” refers to the medical device which delivers long wavelength ultraviolet light to the target site and effectuates the transduction of the desired gene carried by the vector.

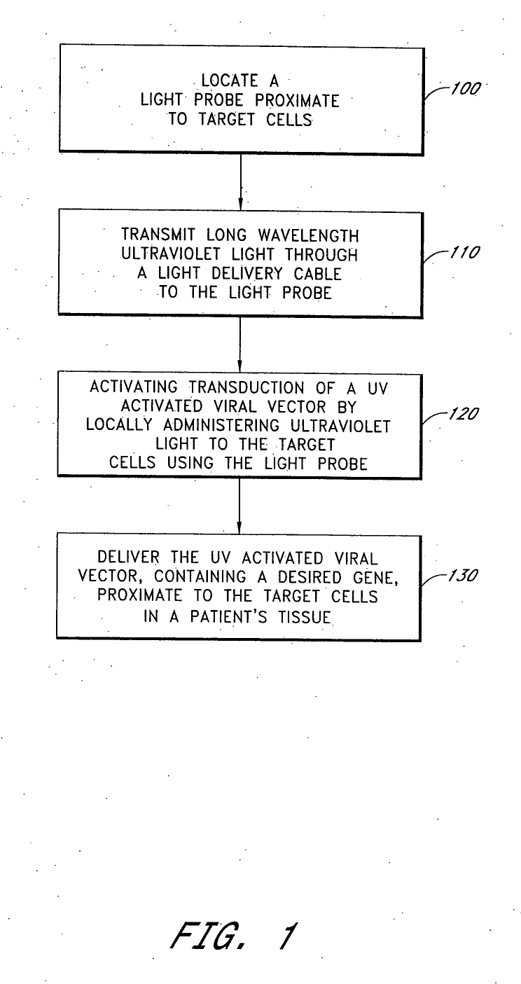

With reference to FIG. 1, a method of treating a patient's tissue is shown. A light probe is located 100 proximate to target cells. Long wavelength ultraviolet (UV) light is then transmitted 110 through a light delivery cable to the light probe. The transduction of the viral vector is activated 120 by locally administering ultraviolet light to the target cells using the light probe. Preferably, the wavelength of the UV light ranges from about 255 nm up to and including about 400 nm. A UV activated viral vector containing a desired gene is delivered 130 proximate to target cells in a patient's tissue. In other preferred embodiments, the wavelength of the UV light ranges from about 280 nm to 400 nm or from about 280 nm to about 330 nm. More preferably, the locally administered UV radiation has a wavelength from about 315 nm to about 355 nm, most preferably about 325 nm. In an alternate embodiment the ultraviolet radiation has a wavelength of about 4 nm to about 400 nm, while in two other alternate embodiment the ultraviolet radiation has a wavelength of 290 nm and 325 nm, respectively.

It should be noted that the method of FIG. 1 may be performed in other preferred embodiments in a different order than the textually outlined above. For example, in another preferred embodiment the vector is delivered prior to locally administering the ultraviolet light.

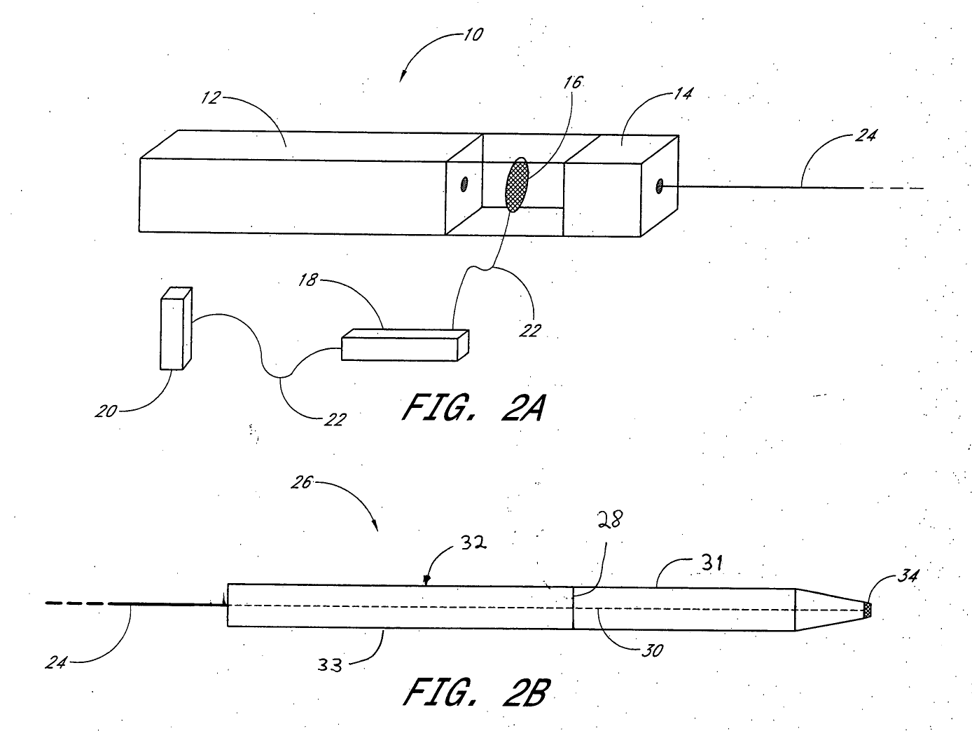

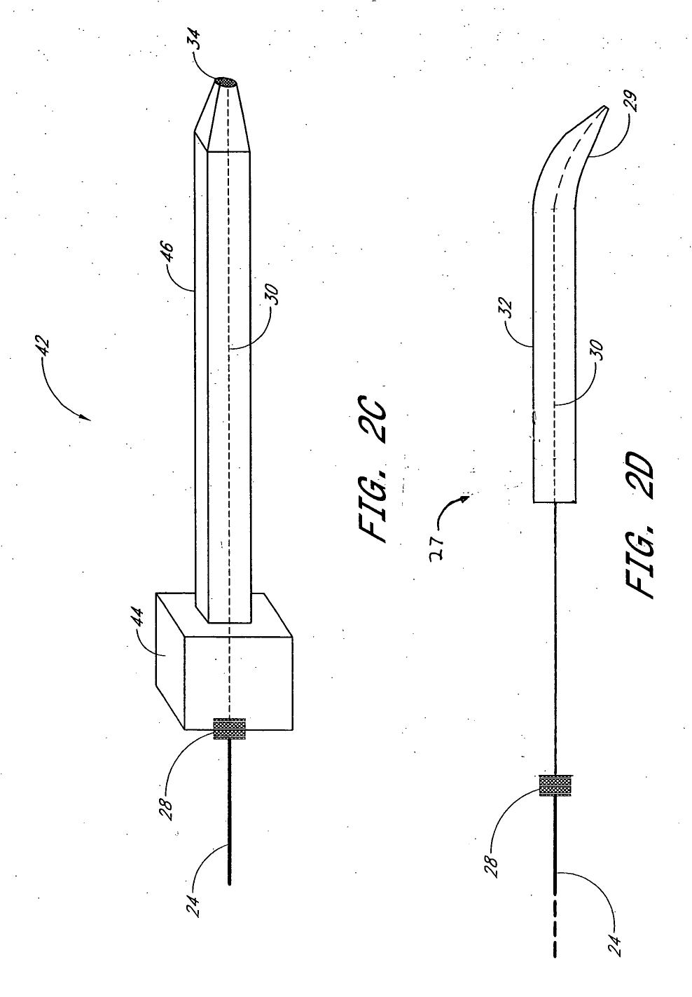

FIGS. 2A-2C illustrate separate components of a UV radiation delivery system, with FIG. 2A showing the UV light generator 10, user interface system, and FIG. 2B and FIG. 2C showing in vivo and ex vivo versions, respectively, of the light probe 26, 42. The light probe 26, 42 is operatively connected to the UV light generator 10 by the light delivery cable 24.

With reference to FIG. 2A, the UV radiation delivery system includes a light source 12 with the desired wavelength UV output. In addition, an optical coupler 14 transmits the light from the light source 12 into a light delivery cable 24, such as an optical fiber cable or bundle, that transmits the light to the target site via a light probe 26 (FIG. 2B). A timed shutter 16 is located in the path of the light beam between the light source 12 and the optical coupler 14 in order to control the length of time the patient is exposed to UV light via the light probe (FIG. 2B-2D). The timed shutter 16 is operatively connected via connectors 22 to a shutter controller 18 and a shutter control interface 20. Preferably, the coupler 14 also includes a lens (not shown) for focusing light into the light delivery cable 24. In the embodiment shown in FIG. 2A, the light source 12 is contained within a housing, while in certain alternate embodiments the light source 12 is operatively joined to the housing.

FIG. 2B shows a light probe 26 as part of an in vivo UV radiation delivery system for use with the light source and user interface, such as those shown in FIG. 2A. The light probe 26 is configured to locally irradiate target cells infected by a UV activated viral vector with long wavelength ultraviolet (UV) light. The light delivery cable 24 is joined with the housing 32 to transmit UV light into a light guide 30 extending through both the probe body 33 and tip 31. The housing of the embodiment shown in FIG. 2B includes the tip 31 joined to the body 33 via an optical connector 28. The light probe 26 is configured to fiber-optically transmit an appropriate UV wavelength light, which originates from the light source 12, through a light guide 30 to a light guide terminator 34 in order to “activate” r-AAV transduction in target cells. A shaft housing 32 preferably surrounds the light guide 30.

The light guide 30 can comprise a light transmitting core, such as a fiber optic core. In certain preferred embodiments the light guide terminator 34 is a microlens or cylindrical diffusing lens while in other preferred embodiments the light guide terminator 34 is not a lens. Instead, in these embodiments, the light guide terminator is the distal end of fiber optic fiber, e.g., a non-angled or angled fiber tip, as in FIG. 2D. Preferably, the light guide 30 is an optical fiber.

The optical connector 28 preferably provides a low energy loss coupling. The optical connector 28 can be a one or two-piece design. For example, low energy loss across the connector can be achieved by precisely aligning the light delivery cable's fiber optic core with the light probe's fiber optic core, e.g., a two-piece connector, such as a multi-pronged ends surrounding a fiber core similar. In an alternate arrangement, the fiber optic cores of the light delivery cable and light probe are sized for efficient coupling between the two. For example, the fiber optic core of the light delivery cable could be 100-125 microns in diameter and the fiber optic core of the light probe tip could be 200 microns in diameter.

In FIG. 2B, the light probe tip 31 is detachable from the body 33 and configured to be the only component that is in contact with the patient. Advantageously, this construction allows the tip 31 to be more easily sterilized or disposed of, while allowing the remainder of the probe body 33 to be reused. A detachable tip 31 also enables multiple types of light probe tip designs to be utilized with the same light probe body 33.

As shown in FIG. 2C, in accordance with alternate preferred embodiments, an ex vivo light probe 42 for use with the light source 12 and user interface components of FIG. 2A is provided to form an ex vivo UV radiation system. In this ex vivo embodiment, the light probe 42 is designed for non-surgical use, such as the irradiation of a patient's skin or irradiating tissue which has been removed from a patient for the purpose of later being returned into the patient. The ex vivo configured light probe 42 has a handle 44, preferably a form fitting handle configured to allow the effective manual manipulation of the probe 42. The light probe 42 configured for external applications also has a shaft housing 46 surrounding a light guide 30 and a light guide terminator 34. An optical connector 28 channels the light from the light delivery cable 24 and preferably allows the light probe 42 to be selectively detached from the light delivery cable 24 when desired.

FIG. 2D illustrates an angled light probe 27 including an angled tip portion 29 (i.e., a tip portion angled to be non-parallel to the housing) preferably for use as part of an in vivo UV radiation delivery system shown in FIG. 2A. The light guide 30 or fiber optic core extends from the proximal end of the housing to the optical connector 28 which is selectively detachable from the light delivery cable 24. In alternate embodiments, the light guide can extend from a point between the distal and proximal ends of the probe, e.g., the light guide can be angled from the side of the housing. Preferably, the angled portion 29 is angled to pass through a cannula and access a desired arthroscopic site, such as, e.g., a knee joint. In a preferred embodiment, the angled light probe is designed employing the factors discussed in Example 2, such as an angling an output face of the light guide terminator, as well. In an alternate embodiment, a reflective member at the tip of a straight fiber optic cable is used to direct the output rays perpendicular to the primary probe axis using a prism and/or a mirror. In another alternate embodiment the light guide terminator is a tip lens.

The light probes 26, 27 are preferably shaped in the form of an arthroscope and interchangeable with light probes having a differing configurations. For example, the light probe tip and/or body can be configured to have different forms in order to more effectively access different treatment sites. In certain embodiments the tip 31 is preferably detachable and replaceable with other tips configured to access similar or different sites in a patient. Preferably, the optical connector 28 allows the light probe 26 to be selectively detached from the light delivery cable 24 when desired.

The entire probe is preferably configured to be both sterile and disposable. In embodiments in which the tip is detachable from the body the entire light probe is preferably configured to be sterile, but preferably only the tip is disposable. In certain embodiments, the UV radiation delivery system also includes a targeting laser beam (not shown) to enable accurate delivery of the light. Standard surgery tools as recognized by those skilled in the art, for example cannulas and trochars, may also be incorporated into the disclosed method.

It should be understood that the exact shape and size of the light probe shown in FIG. 2B and 2D, and especially the tip of the light probe, will vary depending on the particular application and target site as would be understood by one skilled in the art. For example, the light probe can be configured to access an intervertabral disc in a patient's spine or the cartilage in a patient's joint (e.g., the angled tip of FIG. 2D). The preferred embodiments include a light source comprising a laser tuned to the appropriate long UV wavelength. In preferred embodiments, the UV radiation delivery system, whether it be a lamp or laser based system, will be optimized based on considerations such as cost and technical simplicity. In addition, the UV radiation delivery system can also include a targeting laser beam to enable accurate delivery of the light. Standard surgery tools, for example cannulas and trochars, may also be used.

In a preferred embodiment, the optical coupler connection will be established and/or optimized during the manufacturing process and will preferably only be readjusted periodically by a trained technician. As a result, the surgeon does not need to perform a difficult optical alignment of the light delivery cable fiber optic core with the optical coupler, a precision alignment process (e.g., mis-alignment errors can result if the light emerging from the coupler lens is microns off of the center of the light probe core).

The optical connection between the probe and the light delivery cable is preferably a direct fiber to fiber connection, e.g., multi-pronged ends surrounding a fiber core. While proper alignment is important, alignment is preferably not dependent upon as sensitive alignment process as with the optical coupler because preferably no lens is involved. The optical connection preferably allows for a correct, reproducible connection to be made easily by an operating room technician swapping the individual probes in order to employ a probe best suited for particular procedure. In addition, this connection preferably includes a fail safe design so that, if the probe body, tip, and/or light delivery cable are connected incorrectly, the laser will not be outputted from the probe. When the tip is detachable from the probe body, the connection between the probe body fiber and the tip fiber is preferably a selectively detachable fiber to fiber connection, while the optical connection between the light delivery cable and the probe body is preferably joined during manufacturing. Accordingly, the detachable tip configuration of the preferred embodiments is advantageously configured to light delivery in a medical environment.

Alternate embodiments employ as a light source, a lamp, such as a high intensity argon lamp. In these alternate embodiments, the light delivery system further includes a wavelength selecting device, such as a dichroic mirror and/or optical filter, set to transmit long wavelength UV and reject unwanted light wavelengths. In these embodiment, the wavelength selecting device and the dichroic mirror are preferably contained in the same housing as the light source.

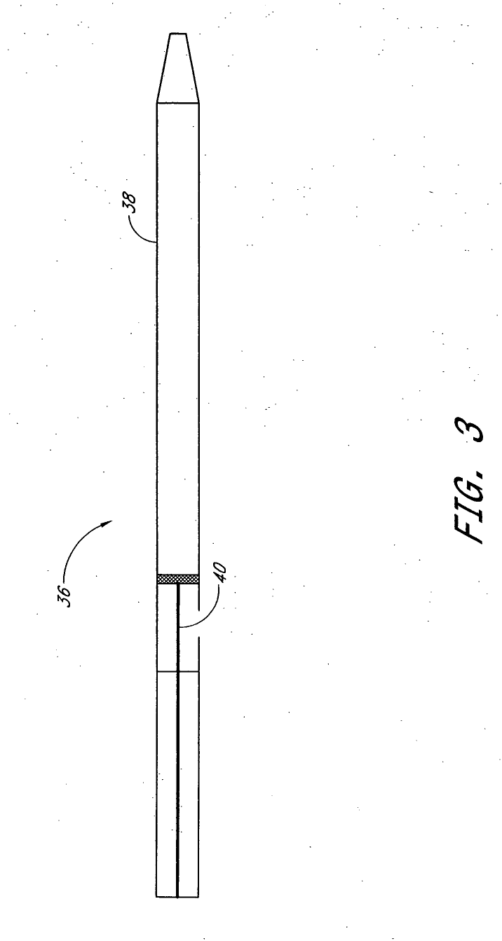

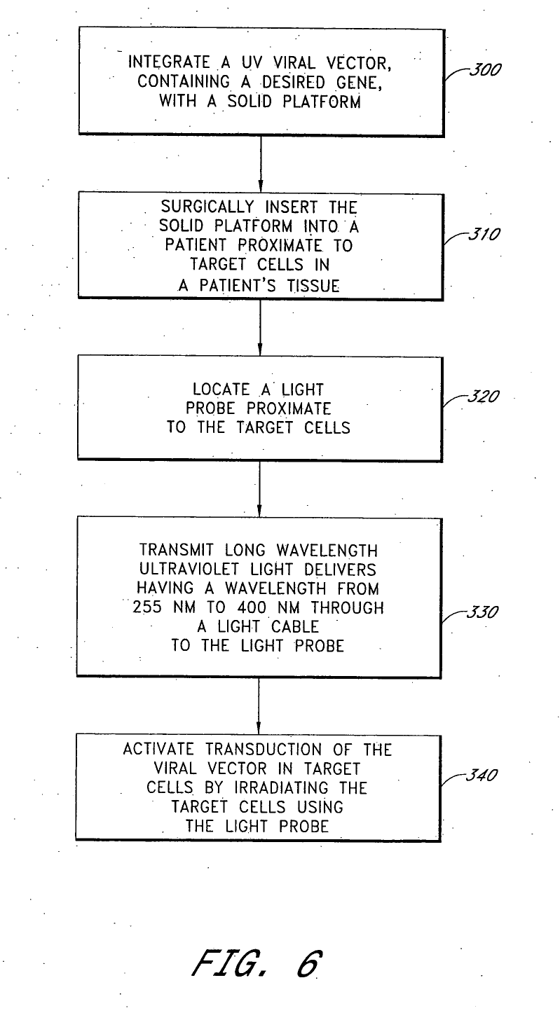

As shown in FIG. 3, an injecting device 36 having a housing 38 and a plunger mechanism 40 is preferably employed in conjunction with the UV radiation delivery system of FIGS. 2A and 2B. Preferably, the injecting device 36 is configured for delivering a UV activated viral vector, such as r-AAV, to the target site using minimally invasive surgical techniques. In alternate preferred embodiments, the injecting device can be configured to inject an implant or solid platform to a target site in a patient (FIG. 6).

Surgery tools, other than injecting device shown in FIGS. 3, which can be involved in certain preferred embodiments include a cannula, a trochar and other tools which the skilled artisan would recognize as being advantageous in conjunction with the embodiments provided herein.

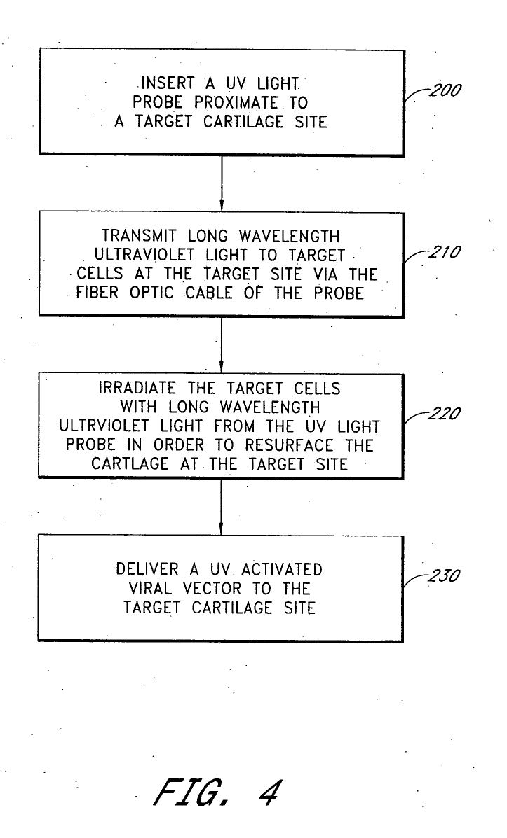

Referring to FIG. 4, a method is provided for the treatment of damaged, such as a cartilage tear. A UV probe is inserted 200 proximate to a cartilage target site. Preferably, if desirable, torn cartilage is removed via standard arthroscopy. Long wavelength ultraviolet light (i.e., greater than or equal to 255 nm) is transmitted 210 to the target cells via the fiber optic cable of the UV probe and the target cells are irradiated 220 with the long wavelength ultraviolet light in order to effectuate the resurfacing of the target cartilage site. A UV activated viral vector, such as r-AAV, is delivered 230 proximate to the target site, preferably by injection. It should be noted that the method of FIG. 4 may be performed in other preferred embodiments in a different order than the order textually outlined above.

Another preferred embodiment is a method of reusing a light probe body portion of a light probe configured to output 255 to 400 nm ultraviolet light to activate a viral vector in a patient. A first light probe tip is removed from the light probe body and second light probe tip is then attached to the body. For example, the same probe body can be used to access different treatment sites by exchanging the light probe tips. The probe body, once sterilized, can also be reused for different patients by replacing the tip with another tip selected for a similar or different treatment site.

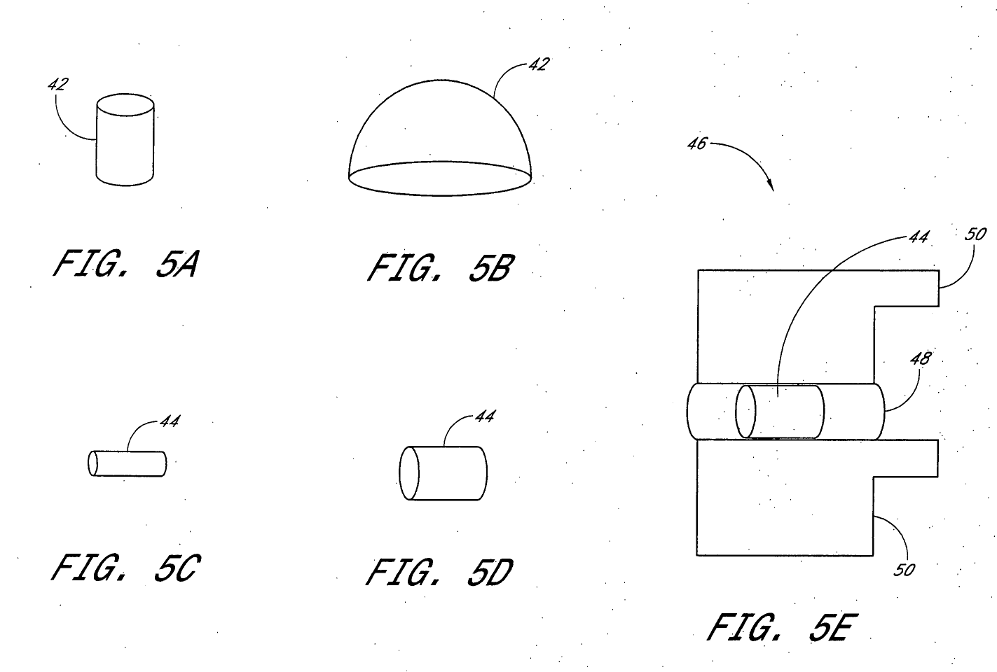

Referring to FIGS. 5A-5E, alternate preferred embodiments provide an implant system and methods for use thereof including the use of implants which serve as solid platforms at the target site (e.g., to create temporary mechanical rigidity between vertebra) while the target cells respond to the introduction of the desired gene into the patient's tissue. Preferably, these carefully engineered implants can be expandable in order to allow insertion through a minimal incision. In addition, these implants can be formed in a number of shapes, including (but not limited to) an unfolding geodosic dome 42 or tetrahedron (not shown), umbrella/dome (not shown), an expanding cylinder 44, and springs which uncoil to increase diameter. Expanding cylinder 44 is shown in a compacted shape in FIG. 5C and an expanded state in FIG. 5D (and also FIG. 5E), while unfolding geodosic dome 42 is shown in a compacted shape in FIG. 5A and an expanded state in FIG. 5B. Preferably, these implants are produced with implant integrated UV activated viral vector. For example, r-AAV can be integrated with the implant through bonding or coating the r-AAV to the implant, absorbing the r-AAV into the implant, and/or baking the r-AAV to the implant surface. In alternate preferred embodiments the implant is delivered to a target site separate from the UV activated viral vector.

FIG. 5E shows a spinal treatment site which the light probe 26 (FIG. 2A) is, in certain preferred embodiments, configured to access. An expanding cylinder 44, to which a UV activated viral vector is preferably integrated, is also, in some preferred embodiments, located between two vertebra 50 in order to facilitate the rebuilding or repair of the intervertebral disc 48. These solid platforms are preferably designed as surgical implants. Non-limiting examples of solid platforms with which UV activated viral vectors could be integrated include spinal spacers, as shown in FIG. 5E, and also total joint replacements such as hip implants, coronary stints and other surgical implants. These examples are provided only for illustrative purposes and should not be considered in any way to limit the present invention. Certain preferred embodiments of the present invention include a UV activated viral vector integrated with a solid platform designed to facilitate the infection of cells proximate to the target site at which the solid platform is inserted. In an alternative embodiment, the vector is delivered to the target site in a step separate from the insertion of the implant.

It should be understood that structural support implants incorporating such conventional structures as, for example, but not limited to, plates, rods, wire, cables, hooks, screws, are also advantageously useful with preferred embodiments provided herein. The support structure may be formed from material such as, but not limited to, metal, carbon-fiber, plastic, and/or reabsorbable material.

FIG. 6 provides a method of treating a patient using UV activated viral vector in conjunction with a solid platform, such as a spinal or joint implant. A UV activated viral vector containing a desired gene is integrated 300 with a solid platform. Preferably, the vector is integrated with the solid platform by bonded, baked, coated, and/or absorbing. The solid platform is then inserted 310 into a patient proximate to target cells in a patient's tissue. A light probe is located 320 proximate to the target cells and long wavelength ultraviolet light, having a wavelength from 225 nm to 400 nm, is transmitted 330 through a light delivery cable, such as a fiber optic cable or bundle, to the light probe. The transduction of the viral vector is activated 340 by irradiating the target cells using the light probe.

Embodiments of the present invention include both in vivo and ex vivo applications. In the ex vivo application the long wavelength UV light dose is applied to cells or biological material external to the patient and then delivered, preferably through injection, to the desired site of treatment. In the in vivo application the LAGT probe and the UV activated viral vector are preferably introduced to the treatment site using minimally invasive surgical techniques, such as stab incisions. Alternate in vivo embodiments employ direct visualization surgical techniques.

A UV activated viral vector is any virus, or recombinant thereof, whose replication is regulated by ultraviolet light. Preferred embodiments of UV activated viral vectors are viruses with single stranded DNA, the virus being capable of allowing a therapeutically significant increase in virus transduction when a virus infected target cell is exposed to a therapeutic doses of ultraviolet radiation. More preferred embodiments include UV activated viral vectors capable of infecting non-dividing cells, effectuating sustained target gene expression, eliciting a low immune response to the vector, and possessing an ability to transduce a large variety of tissues.

Proof of principle experiments, both ex vivo and in vivo based, are currently under way and can determine the optimal wavelengths for activating the gene therapy. The determination of more preferred wavelengths is based on among other factors, the ability to effectively penetrate a target cell, ease and efficiency of fiber optic transmission, the ability to trigger r-AAV transduction, and the length of time a patient must be exposed to receive a therapeutic dose of ultraviolet radiation. Preferably, the LAGT system delivers long wavelength ultraviolet radiation in the range of 315 nm to 400 nm. Current experiments support the use of ultraviolet radiation having a wavelength from 315 nm to 355 nm, more particularly about 325 nm, but it is believed that these experiments will ultimately support ultraviolet radiation having a wavelength from 315 nm to 400 nm. In addition, alternate embodiments employ a laser which produces ultraviolet radiation having a wavelength of about 290 nm. Once specific wavelengths are determined, the disclosed components can be optimized for these specific wavelengths.

The wavelength of the ultraviolet light generated in order to activate UV activated viral vector transduction, including r-AAV transduction, in target cells is preferably 255, 256, 258, 265, 275, 285, 290, 295, 305, 314, 325, 335, 345, 355, 365, 375, 385, 395, or 400 nanometers. More preferably, the wavelength of the ultraviolet light is 290, 295, 300, 305, 310, 315, 316, 317, 322, 325, 327, 332, 337, 342, 347, 352, 357, 362, 367, 372, 377, 382, 387, 392, 393, 394, 395, 396, 397, 398, or 399 nanometers. Most preferably, the wavelength of the ultraviolet light is 325 nanometers.

Tables 1-3 are charts of example growth factors, signaling molecules and/or transcription factors which desired genes, selected based on the desired use (e.g., implant integrated vs. in solution) and outcome (e.g., osteo-integration, spine fusion, perioprosthetic osteolysis, and/or cartilage repair/regeneration) once inserted into a UV activated viral vector could be encoded for. The lists contained in Tables 1-3 are provided for illustrative purposes and should not be taken as limiting the embodiments of the invention in any way.

TABLE 1
osteo-integration and/or spine fusion:
(a) GROWTH FACTORS

Transforming Growth Factor beta (TGFb) 1, 2 and 3
bone morphogenetic protein (BMP) 1, 2, 4, 6 and 7
parathyroid hormone (PTH) parathyroid
hormone related peptide (PTHrP)
fibroblast growth factor (FGF) 1, 2
insulin-like growth factor (IGF)

(b) SIGNALING MOLECULES AND
TRANSCRIPTION FACTORS

LMP-1
Smad 1, 5, 8 dominant-negative Smad 2, 3
Smurf2
Sox-9
CBFA-1
ATF2

TABLE 2
perioprosthetic osteolysis:

soluble tumor necrosis factor receptors TNFR, TNFR:Fc
osteoprotegerin (OPG)
interleukin-1 receptor antagonist (IL-1RA), IL-1RII:Fc
interleukin-4,10 and viral IL-10

TABLE 3
LAGT for cartilage:
(a) GROWTH FACTORS

Transforming Growth Factor beta (TGFb) 1, 2 and 3
bone morphogenetic protein (BMP) 1, 2, 4, 6 and 7
parathyroid hormone (PTH) parathyroid hormone
related peptide (PTHrP)
fibroblast growth factor (FGF) 1, 2
insulin-like growth factor (IGF)
osteoprotegerin (OPG)

(b) SIGNALING MOLECULES AND
TRANSCRIPTION FACTORS

Sox9
Smad 2, 3, dominant-negative Smad 1, 5, 8
Smurf 1, 2
ATF2
CREB

The results of a completed proof of principle experiment are shown in Example 1.

### EXAMPLE 1

I. Methods

A. Isolation of Human Mesenchymal Stem Cells

Human Mesenchymal Stem Cells (HMSC) were isolated from patient blood samples harvested from the iliac crest. The blood samples were diluted in an equal volume of sterile Phosphate Buffered Saline (PBS). The diluted sample was then gently layered over 10 ml of Lymphoprep (Media Prep) in a 50 ml conical tube (Corning). The samples were then centrifuged at 1800 rpm for 30 minutes. This isolation protocol is a standard laboratory technique, and the resulting gradient that formed enabled the isolation of the hMSCs from the layer immediately above the Lymphoprep. The isolated fraction was placed into a new 50 ml conical tube, along with an additional 20 ml of sterile PBS. The sample was centrifuged at 1400 rpm for 8 minutes. The supernatant was removed, the cell pellet was resuspended in 20 ml for fresh PBS, and centrifuged again for 8 minutes at 1400 rpm. Afterwards the supernatant was removed, the cell pellet was resuspended in 10 ml of Dulbecco's Modified Eagle Medium (DMEM) with 10% Fetal Bovine Serum (FBS) and 1% Penicillin/ Streptomycin (P/S) (Invitrogen). The hMSCs were grown and passed as necessary in a 37°/5% CO₂, water-jacketed incubator (Forma Scientific).

B. 325 nm UV Treatment of Human Mesenchymal Stem Cells

Prior to irradiation, hMSCs were plated at a density of 5×10⁴ cells/well in 12-well plates. The cells were allowed to sit down overnight. The next morning the media was removed immediately prior to irradiation. The cells were irradiated at various doses (500 J/m², 1000 J/m², 3000 J/m², 6000 J/m², or 10,000 J/m²) of 325 nm UV light using a helium-cadmium laser system (Melles Griot). After irradiation, fresh media, either with or without recombinant adeno-associated virus was added to the wells.

C. Infection of Human Mesenchymal Stem Cells with Recombinant Adeno-Associated Virus

Infections were carried out in 12-well dishes. The cells were infected at various multiplicities of infection (MOIs=10, 100, and 1000), using a recombinant adeno-associated virus carrying the bacterial β-galactosidase reporter gene (rAAV-LacZ via UNC-Chapel Hill Gene Therapy Vector Core Facility). After being irradiated, the cells were infected with the predetermined amount of virus in a total volume of 500 μl of DMEM/10% FBS/1% P/S. Two hours after the initial infection, an additional 1 ml of media was added to the cultures. The cultures were then allowed to incubate (37°/5% CO₂) for forty-eight hours before harvest for analysis.

D. Quantifying Recombinant Gene Expression

Forty-eight hours after infection, the cells were harvested; cell lysates were made and analyzed using a commercially available Luminescent β-gal Reporter System (BD Biosciences). Briefly, experimental cell samples were removed from the 12-well dish using 0.25% Trypsin-EDTA. The cell suspension was transferred to a 1.5 ml conical tube and the cells were pelleted via a 15 second centrifugation at 13,000 rpm. The cell pellet was washed using two successive rounds of resuspension in ice cold PBS and pelleting for 15 seconds at 13,000 rpm. The final pellet was resuspended in 75 μl of Lysis Buffer (100 mM K₂HPO₄, 100 mM KH₂PO₄, 1 M DTT) and subjected to three rounds of freeze/thaw in an isopropanol dry ice bath and a 37° water bath. The lysates were centrifuged for a final time for 5 minutes at 13,000 rpm. Aliquots (15 μl) of the resulting supernatant were incubated with the provided substrate/buffer solution for one hour and then analyzed using a standard tube luminometer. The read out of this analysis is expressed in Relative Light Units (RLU) in the Results section below.

II. Results

A. Exposure to 325 nm UV Increased the Level of Reporter Gene Expression

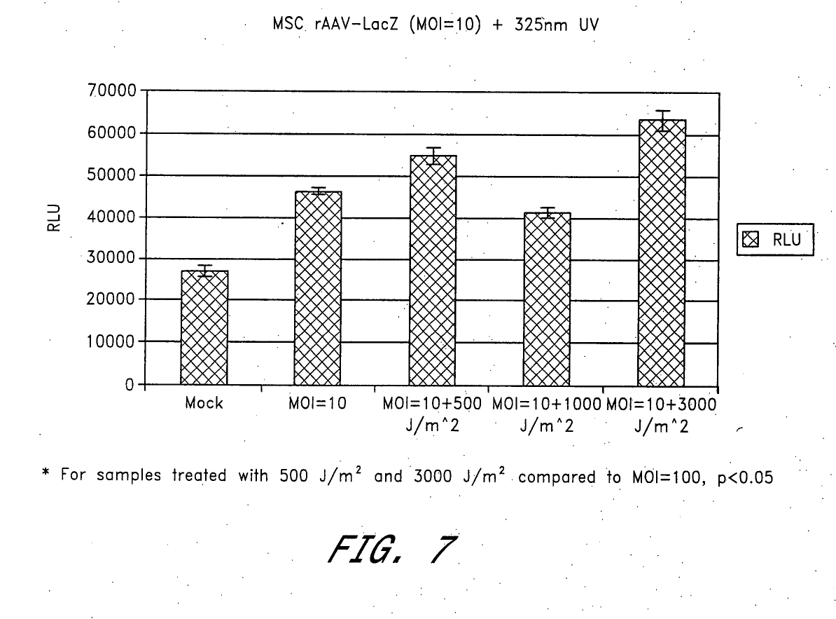

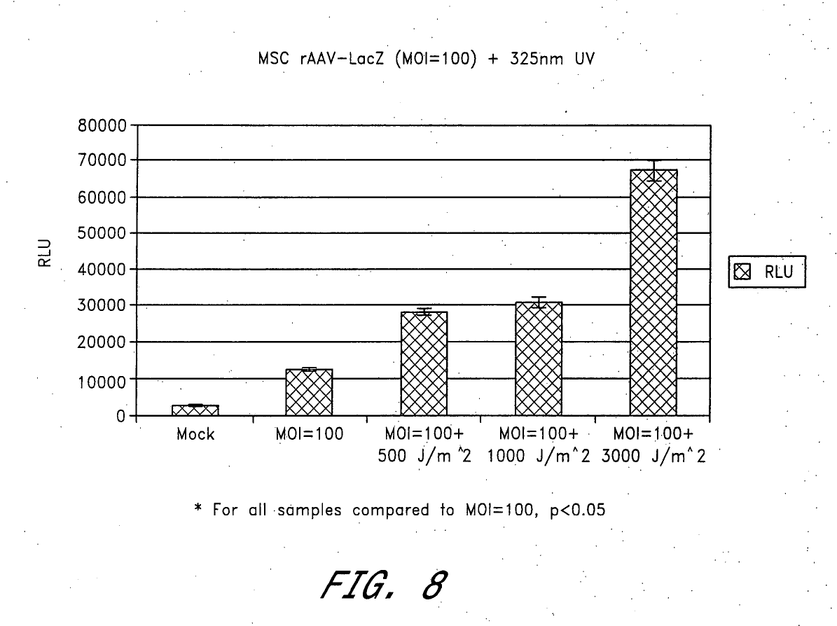

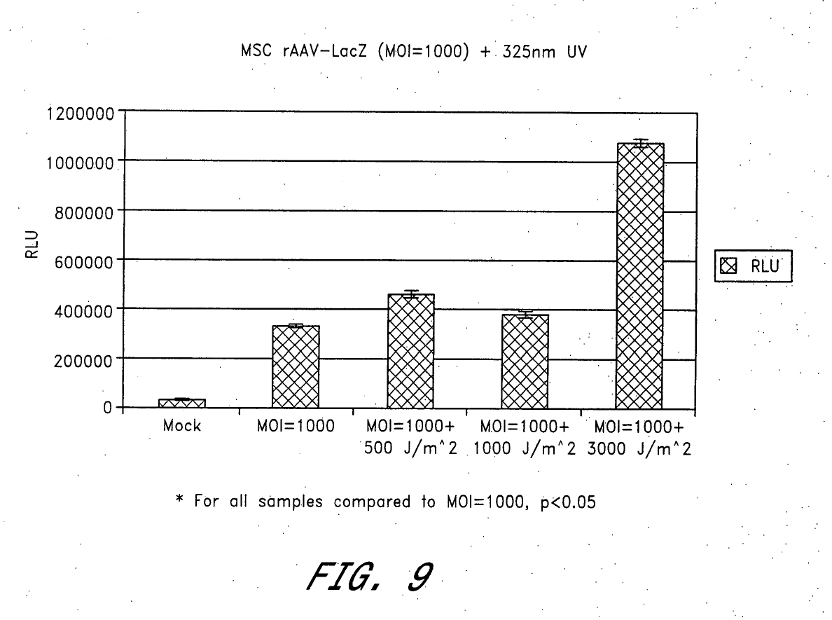

Exposure to 325 nm UV prior to infection with rAAV-LacZ had a dose dependent increase in LacZ reporter gene expression at each of the MOI's used. The controls for each experiment were as follows: Mock (cells alone, no treatment) and cells treated with each of the various UV dosages (500 J/m², 1000 J/m², 3000 J/m², 6000 J/m², which had RLU levels consistent with the Mock cultures (data not shown). Statistical significance was calculated using the Student T-Test. The results are shown in FIGS. 7-9.

### EXAMPLE 2

Example 2 details some of the the design considerations for configuring the light probe disclosed herein for specific applications, e.g. in vivo applications such as arthroscopic surgery on a patient's functional spinal unit (FSU) or joint. A cannula for inserting for introducing the camera system and imaging lens into the knee is provided having a 5-9 mm diameter. The standoff distance of the fiber optic tip to the cartilage is 1-15 mm and the minimum static bend radius for a 200 micron fiber is 24 mm. The output surface of the fiber tip is preferably normal or negative tilted to the bend so that the emitted light continues away from the probe primary axis. The maximum recommended long term bend radius of the 200 micron fiber is 24 mm. For example, if the assumptions are that the cannula has a 5 mm internal diameter for insertion of the fiber optic handpiece and the body of the handpiece is 2 mm outer diameter, then the allowed bend would provide a 30° angle for the principle ray at the fiber optic exit face. The resultant angle of the exiting principle ray in the body fluid is calculated using Snell's law.

N_{f} sin θ_{f}=N_{b} sin θ_{b}

Where N_{f} is the refractive index of the fiber 1.45

θ_{f} is the beam angle with respect to the fiber output face 60°

N_{b} is the refractive index of the body fluid around the knee 1.35

θ_{b} is the angle of the beam entering into the body fluid

Solving Snell's equation for θ_{b} provides a principle ray angle of 67.8° in the body fluid medium, or a 22.2° with respect to the main axis of the fiber handpiece. The angle of the principle ray can be made to deviate slightly more from the probe primary axis by placing an angle on the fiber optic output face of the tip shown in FIG. 2A or 2D. Specifically, if the face is polished at a −10° angle with respect to the vertical, the principle ray will travel at a 24.4° with respect to the probe primary axis.

The amount of deviation of the exiting beam angle from the probe primary axis is determined by the cannula size and the fiber core diameter. The smaller the fiber core diameter, the smaller bend radius can be imposed on the fiber without creating excess transmission loss and strain of the fiber optic cable. The smaller bend radius will produce a larger angular deviation from the probe primary axis for a fixed cannula opening. Alternately, a larger cannula allows a longer bend radius, which produces a larger angular deviation with a fixed fiber core diameter.

Alternate constructions include the placement of a reflective member at the tip of a straight fiber optic cable to direct the output rays perpendicular to the primary probe axis using a prism and or mirror.

Although this invention has been disclosed in the context of certain preferred embodiments and Examples, it will be understood by those skilled in the art that the present invention extends beyond the specifically disclosed embodiments to other alternative embodiments and/or uses of the invention and obvious modifications thereof. It will be appreciated, however, that no matter how detailed the foregoing may appear in text, the invention may be practiced in many ways. Thus, it is intended that the scope of the present invention herein disclosed should not be limited by the particular disclosed embodiments described above, but should be determined only by a fair reading of the claims that follow and any equivalents thereof.

What is claimed is:

1. A ultraviolet light probe for activating transduction of a UV activated viral vector in target cells comprising:
an elongated exterior housing having distal end and a proximal end;
a light guide partially surrounded by the exterior housing, the light guide extending toward the distal end;
an optical connector joined with the light guide to channel ultraviolet light into the light guide when the optical connector is connected to a light source; and
a light guide terminator located at the distal end, the light guide terminator being configured to output ultraviolet light from the light guide.

2. The ultraviolet light probe of claim 1, wherein the probe is configured to administer ultraviolet light having a wavelength from about 255 nm to about 400 nm.

3. The ultraviolet light probe of claim 1, wherein the probe is configured to administer ultraviolet light having a wavelength from about 280 nm to about 400 nm.

4. The ultraviolet light probe of claim 1, wherein probe is configured to administer the ultraviolet light having a wavelength from about 280 nm to about 330 nm.

5. The ultraviolet light probe of claim 1, wherein the probe is configured to administer ultraviolet light having a wavelength from 315 nm to 355 nm.

6. The ultraviolet light probe of claim 1, wherein the probe is configured to administer ultraviolet light having a wavelength of about 325 nm.

7. The ultraviolet light probe of claim 1, wherein the probe is configured to administer ultraviolet light having a wavelength of about 290 nm.

8. The ultraviolet light probe of claim 1, wherein the UV activated viral vector is recombinant adeno-associated virus (r-AAV).

9. The ultraviolet light probe of claim 1, wherein the light guide terminator is a tip lens.

10. The ultraviolet light probe of claim 9, wherein the tip lens is a microlens.

11. The ultraviolet light probe of claim 9, wherein the tip lens is a cylindrical diffusing lens.

12. The ultraviolet light probe of claim 1, wherein the light guide terminator is configured to output ultraviolet light originating from a laser.

13. The ultraviolet light probe of claim 12, wherein the light guide terminator is configured to output ultraviolet light originating from a laser.

14. The ultraviolet light probe of claim 13, wherein the laser is a helium cadmium laser.

15. The ultraviolet light probe of claim 1, wherein the light guide terminator is configured to output ultraviolet light originating from a lamp.

16. The ultraviolet light probe of claim 1, further comprising a handle attached to the exterior housing, the handle being configured to allow manual manipulation of the probe.

17. The ultraviolet light probe of claim 1, wherein the light probe is configured to locally administer ultraviolet light to a patient's treatment site.

18. The ultraviolet light probe of claim 17, wherein the treatment site is external to the patient.

19. The ultraviolet light probe of claim 1, wherein the light probe is configured to be sterile and disposable.

20. The ultraviolet light probe of claim 1, wherein the light probe is configured for arthroscopic surgery.

21. The ultraviolet light probe of claim 20, wherein the distal end of the probe is angled to access a target site in a patient.

22. The ultraviolet light probe of claim 1, wherein the light probe is configured for minimally invasive surgery.

23. The ultraviolet light probe of claim 22, wherein the light probe is configured to access a patient's joint.

24. The ultraviolet light probe of claim 23, wherein the light probe is configured to access cartilage.

25. The ultraviolet light probe of claim 22, wherein the light probe is configured to access a patient's spine.

26. The ultraviolet light probe of claim 25, wherein the light probe is configured to access an intervertebral disc.

27. The ultraviolet light probe of claim 1, wherein the distal end of the housing is configured to be selectively attached to a probe body.

28. The ultraviolet light probe of claim 1, further comprising a probe body selectively attached to the distal end of the housing.

29. The ultraviolet light probe of claim 1, wherein the optical connector is configured to be selectively connected to a light delivery cable channeling light from an ultraviolet light source.

30. The ultraviolet light probe of claim 1, wherein the distal end of the light probe is configured to activate the transduction of a UV activated viral vector integrated with a surgical implant.

31. The ultraviolet light probe of claim 1, wherein the light guide comprises an optical fiber.

32. The ultraviolet light probe of 31, wherein the optical fiber extends from the proximal end of the housing.

33. The ultraviolet light probe of claim 31, wherein the light guide terminator comprises a distal end of the optical fiber.

34. The ultraviolet light probe of claim 33, wherein the distal end of the optical fiber is angled to output the light at an angle non-parallel to the housing.

35. A method of activating a viral vector in a patient, comprising:
inserting an end of a light transmitting tool into the patient so as to direct light towards the viral vector in the patient;
transmitting ultraviolet light having a wavelength from about 280 to about 400 nm through a core of the light transmitting tool to the end of the tool; and
outputting the ultraviolet light to the viral vector in the patient in order to activate the viral vector.

36. The method of claim 35, wherein inserting the tool comprises arthroscopic surgery.

37. The method of claim 35, wherein inserting the end of the light transmitting tool comprises inserting a detachable tip into the patient without contacting the patient with the body of the light transmitting tool.

38. The method of claim 35, wherein the ultraviolet light is outputted from a tip at the end of the tool, the tip being angled to access an arthroscopic surgery site.

39. The method of claim 38, wherein the site is selected from a group consisting of a patient's joint and spine.

40. The method of claim 35, wherein ultraviolet light is transmitted through a fiber optic core.

41. The method of claim 40, wherein the ultraviolet light is outputted from a core angled at the tool end to administer light at an angle non-parallel to a body of the tool.

42. The method of claim 35, wherein the activated viral vector is recombinant adeno-associated virus (r-AAV).

43. The method of claim 42, wherein the vector is integrated with a surgical implant.

44. The method of claim 35, wherein outputting the ultraviolet light comprises irradiating the viral vector without substantially damaging a patient's tissue surrounding the vector.

45. A method of reusing a light probe body configured to output 255 to 400 nm ultraviolet light to activate a viral vector in a patient:
removing a first light probe tip from the light probe body; and
attaching a second light probe tip to the light probe body.

46. The method of claim 45, further comprising disposing of the first light probe tip.

47. The method of claim 45, wherein the first and second light probe tips are both shaped to access the same site in the patient.

48. The method of claim 45, wherein the first and second light probe tips are each shaped to access different sites in the patient.

49. The method of claim 45, further comprising aligning the second light probe tip with the light probe body.

50. A detachable tip of an ultraviolet light probe for activating a viral vector in a patient, comprising:
an optical connector at a proximal end of the tip;
an optical output at the distal end of the tip, the optical output being configured to output ultraviolet light having a wavelength from about 280 nm to about 400 nm in order to activate a viral vector in the patient; and
a fiber optic core extending between the optical connector and the optical output.

51. The detachable tip of claim 50, additionally comprising a housing enclosing at least a part of said optical output and at least a part of said fiber optic core.

52. The detachable tip of claim 50, wherein the optical connector is configured to join and optically align the tip with a light probe body.

53. The detachable tip of claim 50, wherein the optical output is configured to output ultraviolet light having a wavelength from about 280 nm to about 330 nm.

54. The detachable tip of claim 51, wherein the housing is angled so as to access a target site during arthroscopic surgery.

55. The detachable tip of claim 54, wherein the tip is configured so that the tip contacts the patient and the light probe body does not contact the patient.
